(19) United States
(12) Patent Application Publication
(10) Pub. No.: US 2022/0333956 A1
(43) Pub. Date: Oct. 20, 2022

(54) MAPPING USING OPTICAL FIBER SENSING

(71) Applicant: NEC Laboratories America, Inc., Princeton, NJ (US)

(72) Inventors: Shaobo HAN, Princeton, NJ (US); Ming-Fang HUANG, Princeton, NJ (US); Yuheng CHEN, Princeton, NJ (US); Philip JI, Cranbury, NJ (US); Ting WANG, West Windsor, NJ (US)

(73) Assignee: NEC LABORATORIES AMERICA, INC, Princeton, NJ (US)

(21) Appl. No.: 17/720,245

(22) Filed: Apr. 13, 2022

Related U.S. Application Data
(60) Provisional application No. 63/174,745, filed on Apr. 14, 2021.

(51) Int. Cl. G01D 5/353; G01H 9/00

(52) U.S. Cl. CPC G01D 5/35361; G01H 9/004

(57) ABSTRACT

Distributed fiber optic sensing (DFOS) systems and methods that automatically detect vibration signal patterns from waterfall data recorded by DFOS system operations in real- time and associate the detected vibration signal patterns to GPS location coordinates without human intervention or interpretation. When embodied as a computer vision-based operation according to aspects of the present disclosure, our inventive systems and method provide accurate, cost-efficient, and objective determination without relying on humans and their resulting bias' and inconsistencies.

### CROSS REFERENCE TO RELATED APPLCIATIONS

This application claims the benefit of U.S. Provisional Patent Application Ser. No. 63/174,745 filed 14 Apr. 2021 the entire contents of each is incorporated by reference as if set forth at length herein.

### TECHNICAL FIELD

This disclosure relates generally to distributed fiber optic sensing (DFOS) systems methods and structures. More particularly, it describes DFOS systems and methods that automatically detect vibratory signal patterns from DFOS waterfall data recorded by DFOS systems in real time and map those patterns to GPS coordinates.

### BACKGROUND

As those skilled in the art will readily appreciate, distributed fiber optic sensing systems and methods have shown to be of great utility and provide a range of useful services such as sensing various physical parameters including temperature, vibration, strain, etc., thereby enabling a new era of infrastructure monitoring.

When DFOS systems are employed with a buried optical sensing fiber, the DFOS systems can monitor acoustic vibrations along tens of kilometers of fiber optic cables with meter-scale spatial resolution in real-time for various acoustic events, such as traffic accidents or construction.

As those skilled in the art will understand and appreciate, distributed acoustic/vibration sensing (DAS/DVS) is a linear sensing method that can pinpoint the location of events along the fiber sensor relative to the location of the DFOS interrogator. To precisely map any point along the fiber sensor onto real-world geographic locations, an external vibration source may be used to provide excitation signals. For example, a mechanical vibrator is located near the fiber sensor cable (e.g. on manhole cover) to generate a target or baseline vibration pattern that is recorded in real-time by the DFOS system, and subsequently related to GPS coordinates of the location at the vibrator excitation signal is generated.

As currently performed in the art, recognizing and localizing vibration patterns on DFOS waterfall traces—which result from DFOS operation—relies on human experts who manually label locations by examining recorded DFOS data and pairing/associating it with GPS data.

This manual procedure is inefficient, error-prone, and labor-intensive.

### SUMMARY

An advance in the art is made according to aspects of the present disclosure directed to DFOS systems and methods that automatically detect vibration signal patterns from waterfall data recorded by DFOS system operations in real-time and associate the detected vibration signal patterns to GPS location coordinates.

In sharp contrast to the prior art, our inventive systems and methods according to aspects of the present disclosure advantageously identify the DFOS vibration signal patterns from waterfall data without human intervention or interpretation.

Operationally, a DFOS interrogator is connected to a field deployed fiber optic sensor cable and senses vibrations in the vicinity of the fiber optic sensor cable, generating spatiotemporal data. Our inventive systems and method employ a feature extraction operation/method that detects a targeted vibration excitation signal based on its characteristics. Advantageously, our inventive systems and methods produce estimates of both a center location and width of the vibrator signals relative to an effected length of the fiber optic sensor cable which, in an illustrative environment, may represent a manhole location and inside coil length, respectively. When embodied as a computer vision-based operation our inventive systems and method provide accurate, cost-efficient, and objective determination without relying on humans and their resulting bias' and inconsistencies.

### BRIEF DESCRIPTION OF THE DRAWING

A more complete understanding of the present disclosure may be realized by reference to the accompanying drawing in which:

FIG. 1 is a schematic diagram of an illustrative distributed fiber optic sensing system according to aspects of the present disclosure;

FIG. 2 is a schematic diagram illustrating an overall intelligent cable mapping system according to aspects of the present disclosure;

FIG. 3 is a schematic flow diagram illustrating our automated detection method as compared with a prior art manual method according to aspects of the present disclosure;

FIG. 4 is a flow chart diagram of illustrative method steps according to aspects of the present disclosure;

FIG. 5 is a schematic diagram illustrating a sliding detection window on whole fiber routes according to aspects of the present disclosure;

FIG. 6 is a schematic feature diagram of an illustrative intelligent DFOS cable mapping system according to aspects of the present disclosure; and

FIG. 7 is a schematic block diagram of an illustrative computer system that may be programmed to operate method(s) according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Fiber optic sensing measures changes in “backscattering” of light occurring in an optical sensing fiber when the sensing fiber encounters vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

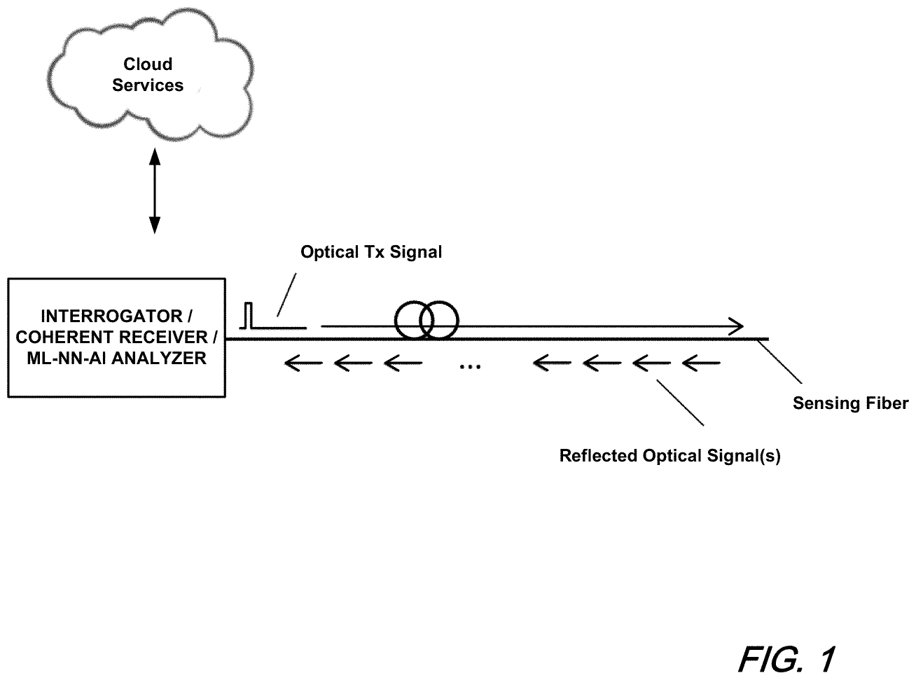

A schematic diagram illustrating the generalized arrangement and operation of a distributed fiber optic sensing system including artificial intelligence analysis and cloud storage/service is shown in FIG. 1. With reference to FIG. 1 one may observe an optical sensing fiber that in turn is connected to an interrogator. As is known, contemporary interrogators are systems that generate an input signal to the fiber and detects/analyzes reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes the interrogator that periodically generates optical pulses (or any coded signal) and injects them into an optical fiber. The injected optical pulse signal is conveyed along the optical fiber.

At locations along the length of the fiber, a small portion of signal is scattered/reflected and conveyed back to the interrogator. The scattered/reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Distributed Acoustic Sensing (DAS)/Distributed Vibrational Sensing (DVS) systems detect vibrations and capture acoustic energy along the length of optical sensing fiber. Advantageously, existing, traffic carrying fiber optic networks may be utilized and turned into a distributed acoustic sensor, capturing real-time data. Classification algorithms may be further used to detect and locate events such as leaks, cable faults, intrusion activities, or other abnormal events including both acoustic and/or vibrational.

Various DAS/DVS technologies are presently used with the most common being based on Coherent Optical Time Domain Reflectometry (C-OTDR). C-OTDR utilizes Rayleigh back-scattering, allowing acoustic frequency signals to be detected over long distances. An interrogator sends a coherent laser puke along the length of an optical sensor fiber (cable). Scattering sites within the fiber cause the fiber to act as a distributed interferometer with a gauge length like that of the pulse length (e.g. 10 meters). Acoustic disturbance acting on the sensor fiber generates microscopic elongation or compression of the fiber (micro-strain) which causes a change in the phase relation and/or amplitude of the light pulses traversing therein.

Before a next laser pulse is be transmitted, a previous pulse must have had time to travel the full length of the sensing fiber and for its scattering/retiedions to return. Hence the maximum pulse rate is determined by the length of the fiber. Therefore, acoustic signals can be measured that vary at frequencies up to the Nyquist frequency, which is typically half of the pulse rate. As higher frequencies are attenuated very quickly, most of the relevant ones to detect and classify events are in the lower of the 2 kHz range.

As we shall show and describe and as already noted, our inventive systems and methods automatically detect/interpret vibration signals resulting from DFOS operation using deployed fiber optic sensor cables to locate cable geographical locations by computer—without human intervention or input. As those skilled in the art will understand and appreciate, such operation presents numerous practical challenges, such as the intra-variability of the target vibration signal(s), and false alarms caused by ambient noises, road traffics, and field construction or other disruptive, vibration producing events.

To solve these issues our inventive systems and methods according to aspects of the present disclosure exhibit:

Signal Detection and Localization in which vibrator signal(s) generate a group of parallel vertical segments (continuous vibration) on waterfall traces, with a certain range of durations, widths, strengths, and oftentimes gaps in-between. Based on these intuitions, we employ a pattern recognition method based on sequences of progressive probabilistic Hough transforms (PPHT).

Our inventive method is customized for this application, which achieves high detection rate and very low false alarm rate. In sharp contrast to deep learning based approaches, our inventive method according to the present disclosure does not require training and data labeling. Additionally, it is not necessary to break or segment an entire fiber optic sensor route into smaller segments to produce an inference. Advantageously, our inventive systems and methods make decisions individually - at each fiber optic sensor cable location. As a result, our systems and methods achieve better localization accuracy. Alternative image processing methods such as Canny edge detection, only considers a subset of the aforementioned characteristics—but not all of them—and therefore produces inferior detection performance tested on field data as compared with our systems and methods according to the present disclosure.

Additionally, our inventive systems and methods exhibit a False Alarm Control that advantageously reduces false alarms, which avoids any confusions during in- field operation. More specifically, during preprocessing, a bandpass filter having designed coefficients is employed to enhance a target signal while suppressing any noise that may generate similar looking patterns. In addition, GPS timestamps are used to exclude construction or other vibrations that occur outside of a vibrator testing period. Finally, during post-processing, an event tracker is monitors vibrations with moving windows at the same locations, such that intermittent construction events with durations longer than expected are recognized as false alarm.

To establish a precision map of a buried fiber optic sensor cable route, first, a sequence of landmark locations with good/suitable accessibility are selected. Usually, manholes/hand holes are selected as landmarks for fiber optic sensor cable routes. Once GPS coordinates are measured and paired with a DFOS fiber distance by the DFOS system operation, the geographical location(s) of any other points along the fiber optic sensor cable can be calculated by interpolation using piecewise linear assumption. One practical challenge is that, there is often an unknown length of slack fiber (coil) inside the manhole/hand hole. Therefore, the length of slack fiber also needs to be estimated.

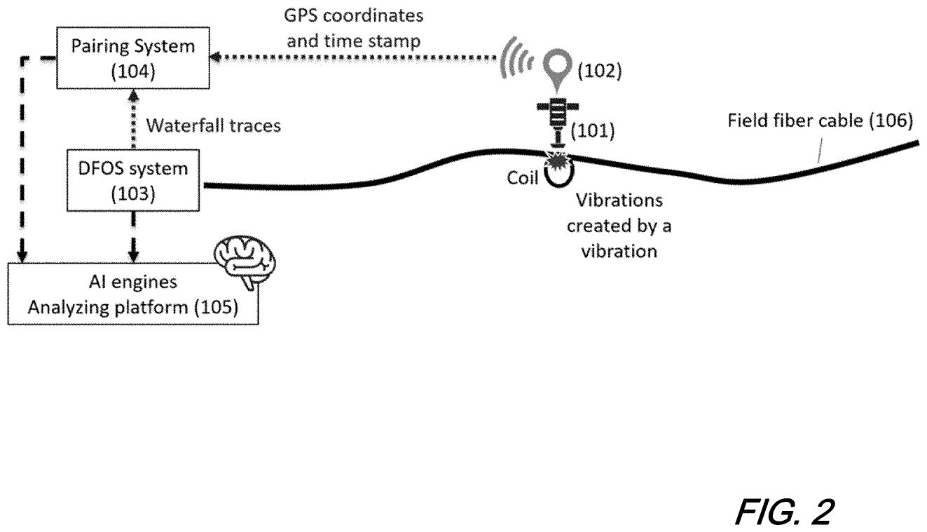

FIG. 2 is a schematic diagram illustrating an overall intelligent cable mapping system according to aspects of the present disclosure. As may be observed from the figure, hardware components illustrated include a vibrator/mechanical excitation device (101), a GPS device (102), a DFOS sensing system (103), and pairing system (104), an on-premise processing unit (105), and an existing fiber optic sensor cable (106).

To localize targeted landmark (i.e., mahole/hand hole) position relative to a a fiber optic sensor cable (buried/aerial/above ground), a DFOS interrogator is connected to the fiber optic sensor cable and continuously operated and monitors vibrations at locations (ever location) along the length of the fiber optic sensor cable. The target vibrator (101) on (or nearby) the manhole cover—for example—is turned on for roughly one minute, which produces a vertical stripe vibration pattern on resulting/collected waterfall traces. A width of the vertical stripe vibration pattern indicates a length of fiber coil located inside the manhole. Meanwhile, a message with GPS (102) coordinates and time-stamp is sent to processing unit (104) for pairing with the acquired sensing data (waterfall traces). This procedure can be repeated on multiple locations on the same fiber cable to localize the entire route (106).

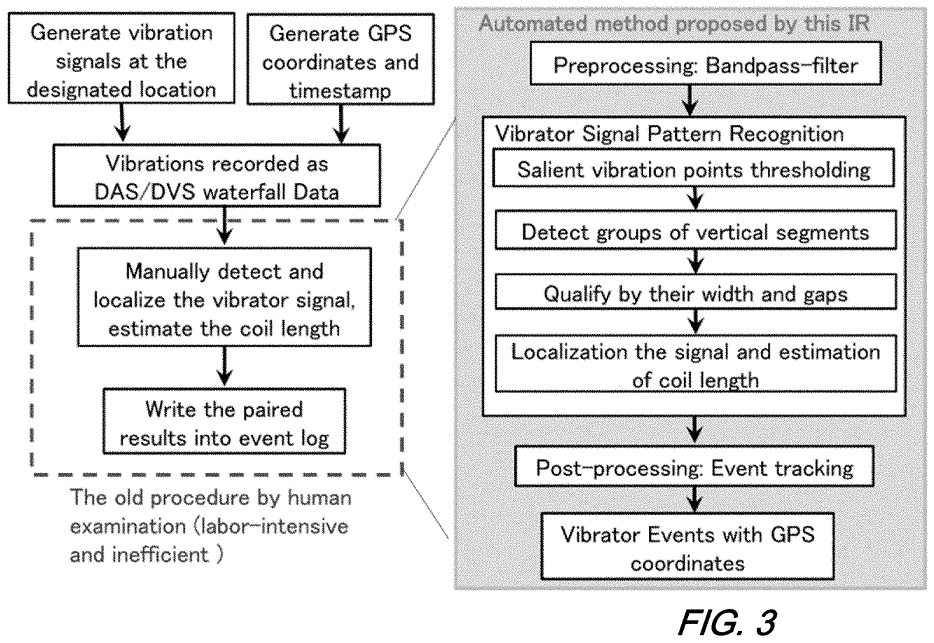

FIG. 3 is a schematic flow diagram illustrating our automated detection method as compared with a prior art manual method according to aspects of the present disclosure. As may be observed from this figure, previously such localization of each vibration signal from waterfall traces was performed manually, by human experts and was prone to error and inconsistency(ies).

As those skilled in the art will understand and appreciate, an exemplary DFOS waterfall signal (plot) of a cable route is plotted such that the x-axis represents location of vibrations along the length of the fiber optic sensor cable while the y-axis represents the time of the vibrations. Colors may be employed to indicate intensity(ies) of the vibrations. As noted, a target signal will exhibit a vertical stripe shape, and it is noted that certain stationary noise signals may exhibit similar vertical shape(s).

The practical challenges of detecting such vertical stripe(s) from the waterfall signals may be summarized as follows:

Variations in Signal Length: The time lap of a DFOS system fluctuates randomly between 60 milliseconds to at least 250 milliseconds (sometimes even longer). Although the length of the target vibration can be controlled to be about one minute, in practice the length of the vertical stripe can be different.

Variations in Signal Width: The lengths of fiber optic sensor cable coils inside each manhole are different. Therefore, the width of the vertical stripe appearing on the waterfall plot also can be different.

Variations in Signal Intensity: The sensitivity(ies) at each fiber location along its length are different. For example, different underground conditions surrounding the fiber optic sensor cable—which can be dry, flooded and iced. In certain locations close to water or high water table(s), an underground fiber optic sensor cable positioned inside a conduit and manholes may be frequently flooded. In other locations—such as desert locations—buried fiber optic sensor cables and manholes are usually quite dry. Hence, any received vibration intensity levels is lower during flooded conditions as a result of its greater damping effects than a dry(er) environment. Additionally, manhole locations may not be easy to access. Therefore, it may not be possible to use a vibrator to directly vibrate/mechanically excite a manhole cover such as when it is located in the middle of a busy roadway and vibration must be performed from a distance—i.e., a sidewalk proximate to the manhole.

As will be appreciated, such factors make the intensity of the vibration signal stronger or weaker. Sometime, the middle part of the coil appears to be the weakest point, which renders the vibrator stripe broken into two vertical stripes in parallel.

Stationary Noise Patterns: There are stationary noise patterns that exhibit patterns similar to those produced by vibrator. Such patterns may persist for a longer duration, may be discontinuous in time, and appear narrower on the waterfall plot. Additionally, two nearby locations exhibit stationary noises, thereby causing further confusion with respect to target vibrator pattern(s).

Rolling Machine Patterns: Road construction machines such as rolling machines may generate patterns that appear to be very similar to those produced by the target vibrator, especially when it is working intermittently. This is a major cause of false alarms if it happens simultaneously with vibrator testing.

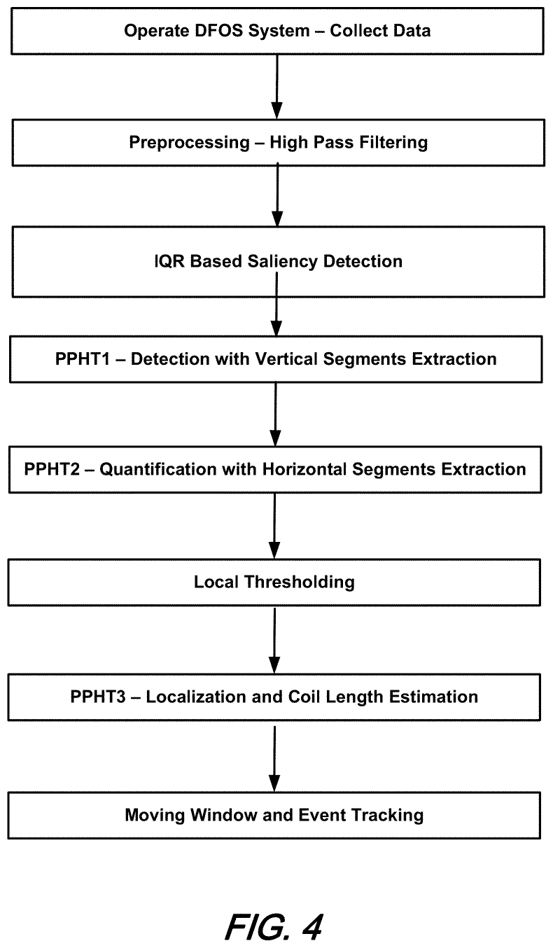

As we have noted, our inventive systems and methods according to the present disclosure provide an automated signal detection method for DFOS system signals, with practical considerations on reducing false alarms. Illustrative steps of our method are shown in FIG. 4 and are described in more detail as follows.

Step 1: Preprocessing (High-pass filtering): The system is considered a high pass filter with cutoff frequency at 30 Hz to reduce the low frequency components from earth vibration.

Step 2: IQR based Saliency detection. The sensed data under a scene is represented as a group of vibrating points {pᵢ},i=1, . . . , N. Each vibrating point is a tuple (tᵢ, xᵢ, vᵢ), where tᵢ is a time-stamp, xᵢ is the spatial location along the cable, and vᵢ is the strength of vibration. Under a sensing scene [tₛₜₐᵣₜ, t_{end}]×[xₛₜₐᵣₜ, x_{end}], a group of vibrating points {pᵢ} is obtained, which satisfies the conditions tₛₜₐᵣₜ<tᵢ<t_{end} and xₛₜₐᵣₜ<xᵢ<x_{end}. The saliency of vibration is determined from its vibration strength. A vibrating point is a salient vibrating point, if its vibrating strength falls more than 1.5×IQR above the third quartile. That is, Salient points >Q₃+1.5×IQR. The IQR of vibrating strength {vᵢ} is calculated as the difference between the upper and lower quartiles, Q₃-Q₁. Since IQR is computed from statistics of each zone over a period, the saliency filter is adaptive and robust.

Step 3: PPHT1—Detection with Vertical Segments Extraction. Rotating the image by 90 degree and setting the accumulator angle to be −90 degree, we apply the progressive probabilistic Hough transform (PPHT) on the set of saliency points, to assess the global evidence of vertical segments. The minimum length of segments is set to be 350, the maximum gap between segments is set to be 1 such that only patterns strictly continuous in time will be extracted. The minimum number of accumulation points is set to be 40. After the segments are extracted, a filter is applied to select those with a length less than the maximum length of segments (set to be 750). Due to the stochastic nature of the algorithm, this procedure is repeated 10 times and the union of the detected segments is preserved. A binary mask is generated by drawing the detected segments from the starting point to the end point on a matrix.

Step 4: PPHT2—Qualification with Horizontal Segments Extraction. Setting the accumulator angle to be −90 degree, we apply the PPHT again, with minimum length (i.e. vibrator width) of segments is set to be 11, the maximum gap between segments are set to be 10 to accommodate the occasionally broken vibrator patterns. The minimum number of accumulation points is set to be 11. After the segments are extracted, a filter is applied to select width maximum length (i.e. vibrator width) set to 100. Again, this procedure is repeated 10 times and the union of the detected segments is preserved. A second binary mask is generated by drawing the detected segments from the starting point to the end point on a matrix. If plotted, it may be observed that construction events may cause false alarms that remain after applying PPHT1 and PPHT2.

Step 5: Local Thresholding. A binary decision at each cable location is obtained by comparing the column sum of the masked waterfall with a pre-specified threshold of 60000.

Step 6: PPHT3—Localization and Coil Length Estimation. Setting the accumulator angle to be −90 degree, apply PPHT on the binary decision vector, with minimum length 3, the maximum gap between segments are set to be 10. The minimum number of accumulation points is set to be 3. After the segments are extracted, a filter is applied to select with maximum length (i.e. vibrator width) set to 100. Again, this procedure is repeated 10 times and the union of the detected segments is kept. The location of vibrator is estimated to be the center of the detected segment, (x_start+x_end)/2. The length of coil is estimated to be the length of the detected segment, abs(x_end−x_start).

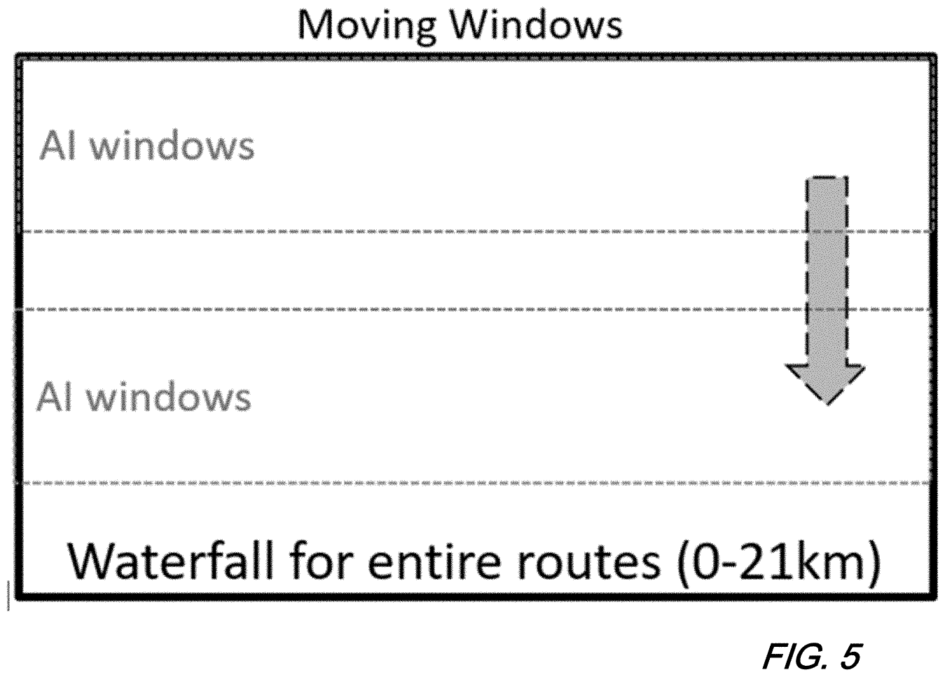

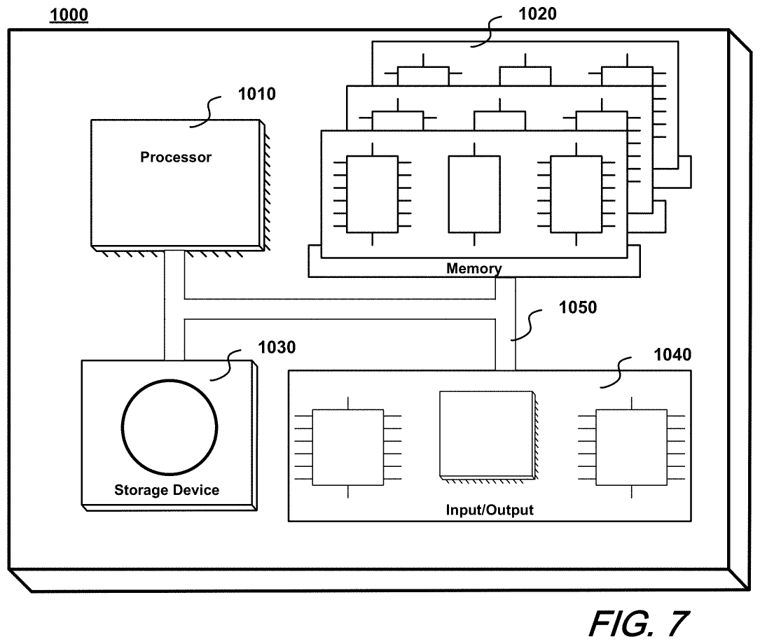

Step 7: Moving window and Event Tracking: The waterfall streams are analyze by sliding window methods, shown in FIG. 5—which is a schematic diagram illustrating a sliding detection window on whole fiber routes according to aspects of the present disclosure. If an event is detected at the same locations, it is tracked with the duration calculated as the last updated time minus the first detected time. A signal is reported to be targeted vibrator signal only if the calculated duration are between 5 seconds and 96 seconds. The purpose is to exclude long road construction signal (intermittent) occurred around the same time as the vibrator test. Our system achieves 100% detection rate with only 1 false alarm reported, during a three-day field test. FIG. 7 shows an example of system output tested on a field collected data

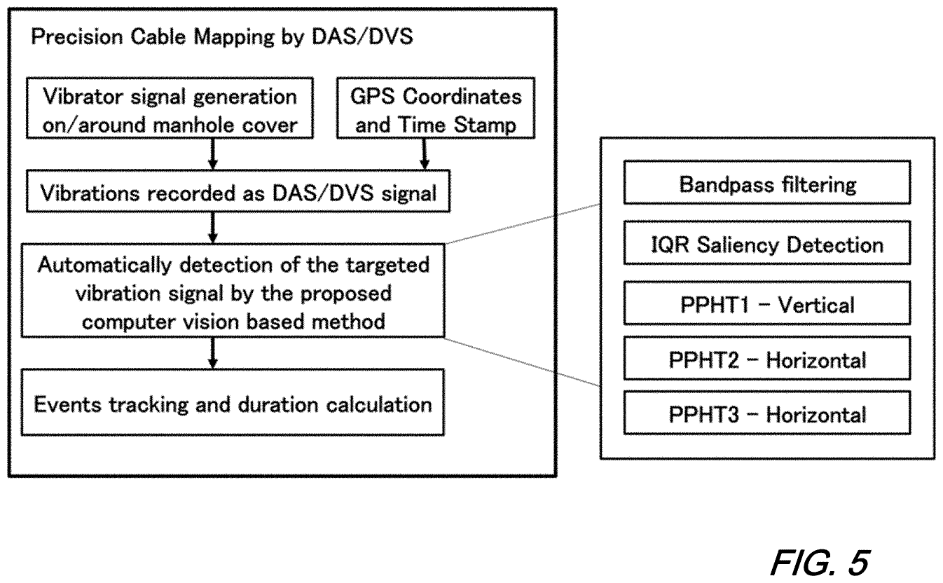

FIG. 6 is a schematic feature diagram of an illustrative intelligent DFOS cable mapping system according to aspects of the present disclosure. We note that systems and methods according to aspects of the present disclosure is the first automated solution that offers precision cable mapping for downstream distributed fiber sensing applications wherein manhole covers are chosen as landmarks and a vibrator/excitation device with designed length of vibration is applied to create a vibration event, which is subsequently detected/recorded/analyzed by DFOS system.

Additionally, our inventive systems and methods employ high-pass filter and saliency detection as preprocessing steps and also uses a sequence of progressive probabilistic Hough transforms, with specially designed parameters for target signal detection and false alarm control. Both the location of vibrator and the length of any slack fiber optic sensor cable are estimated.

Furthermore, systems and methods according to the present disclosure employ a sliding window on the whole sensor fiber route, for event tracking and duration calculation. Sensed events with unexpected durations, despite similar-appearing patterns, can be advantageously precluded. Finally, systems and methods according to aspects of the present disclosure employ automated pairing of GPS coordinates and detected vibration events with an edge device and addresses a core challenge of fine-grained vibrator signal localization with an automated solution, that is scalable to applications of buried cable monitoring involving multiple routes.

FIG. 7 is a schematic block diagram of an illustrative computer system that may be programmed to operate method(s) according to aspects of the present disclosure. As may be immediately appreciated, such a computer system may be integrated into an another system such as a router and may be implemented via discrete elements or one or more integrated components. The computer system may comprise, for example a computer running any of a number of operating systems. The above-described methods of the present disclosure may be implemented on the computer system 1000 as stored program control instructions.

Computer system 1000 includes processor 1010, memory 1020, storage device 1030, and input/output structure 1040. One or more input/output devices may include a display 1045. One or more busses 1050 typically interconnect the components, 1010, 1020, 1030, and 1040. Processor 1010 may be a single or multi core. Additionally, the system may include accelerators etc further comprising the system on a chip.

Processor 1010 executes instructions in which embodiments of the present disclosure may comprise steps described in one or more of the Drawing figures. Such instructions may be stored in memory 1020 or storage device 1030. Data and/or information may be received and output using one or more input/output devices.

Memory 1020 may store data and may be a computer-readable medium, such as volatile or non-volatile memory. Storage device 1030 may provide storage for system 1000 including for example, the previously described methods. In various aspects, storage device 1030 may be a flash memory device, a disk drive, an optical disk device, or a tape device employing magnetic, optical, or other recording technologies.

Input/output structures 1040 may provide input/output operations for system 1000.

1. A distributed fiber optic sensing system (DFOS) mapping method comprising:
providing a distributed fiber optic sensing system (DFOS), said system including a length of optical sensor fiber; and
a DFOS interrogator and analyzer in optical communication with the length of optical fiber, said DFOS interrogator configured to generate optical pulses from laser light, introduce the pulses into the optical fiber and detect/receive Rayleigh reflected signals from the optical fiber, said analyzer configured to analyze the Rayleigh reflected signals and generate location/time waterfall plots from the analyzed Rayleigh reflected signals;
operating the DFOS system while providing mechanical excitations to landmarks along a route of the optical fiber thereby producing vibration events in the optical fiber and recording DFOS signals received during operation while associating location(s) of the landmarks to GPS coordinates of the landmarks;
continuously operating the DFOS system and automatically determining time/location of vibration events from waterfall plots without human intervention and associating the vibration events to a GPS location.

2. The method of claim 1 wherein the time/location of vibration events from waterfall plots without human intervention includes signal pattern recognition of a vibrator device.

3. The method of claim 1 further comprising detection of groups of vertical segments on the waterfall plots.

4. The method of claim 4 further comprising quantifying the detected groups of vertical segments by their width and gaps.

5. The method of claim 4 wherein the automatic determination includes operating a machine vision system that examines the waterfall plots.
